(19) United States
(12) Patent Application Publication
(10) Pub. No.: US 2023/0358487 A1
(43) Pub. Date: Nov. 9, 2023

(54) DOUBLE-FLOW HEAT EXCHANGER

(71) Applicant: Safran, Paris (FR)

(72) Inventors: Ephraïm Toubiana, Moissy-Cramayel (FR); Samer Maalouf, Moissy-Cramayel (FR)

(21) Appl. No.: 18/027,277

(22) PCT Filed: Sep. 22, 2021
(86) PCT No.: PCT/FR2021/051621

§ 371 Date: Mar. 20, 2023

(30) Foreign Application Priority Data
Sep. 23, 2020 (FR) FR2009669

(51) Int. Cl. F28F 13/06

(52) U.S. Cl. CPC F28F 13/06; F28F 2250/06; F28D 2021/0026

(57) ABSTRACT

The invention relates to a heat exchanger comprising a support wall and a first plurality of fins that each stand proud from an outer surface of the support wall and are designed to have a first air flow pass over them. According to the invention, the heat exchanger comprises, downstream of the first plurality of fins, a second plurality of fins that each stand proud from the outer surface of the support wall, the first and second pluralities of fins being separated by distribution means which are configured in such a way that the first air flow flows outside the second plurality of fins and a second air flow flowing outside the first plurality of fins passes through the second plurality of fins.

### FIELD OF THE INVENTION

The present invention relates to the general field of the aeronautic. In particular, it is aimed at a heat exchanger for a turbomachine.

### TECHNICAL BACKGROUND

A turbomachine, in particular for an aircraft, comprises various members and/or items of equipment that need to be lubricated and/or cooled, such as rolling bearings and gears. The heat released by these components, which can be very high depending on the power of the member and/or the item of equipment, is transported by a fluid and evacuated towards cold sources available in the aircraft.

It is known to equip the turbomachine with one or more heat exchange systems to carry out the heat exchange between the fluid (typically oil) and the cold source (air, fuel, etc.). There are even different types of heat exchange systems, such as for example the fuel/oil heat exchangers, generally known by the acronym FCOC (Fuel Cooled Oil Cooler) and the air/oil heat exchangers, known by the acronym ACOC (Air-Cooled Oil Cooler).

The FCOC heat exchangers have a dual function of heating the fuel before the combustion in the combustion chamber of the turbomachine and cooling the oil heated by the thermal dissipations of the turbomachine. However, the FCOC heat exchangers are not sufficient to absorb all the thermal dissipations because the temperature of the fuel is limited for safety reasons.

The additional cooling is obtained by the ACOC heat exchangers, in particular those of the surface type known by the acronym SACOC. The surface heat exchangers are usually arranged in the secondary duct of the turbomachine and use the secondary air flow to cool the oil circulating in the turbomachine. These heat exchangers are in the form of a metallic surface part allowing the passage of oil in machined channels. The secondary air flow is guided along fins carried by this surface part and which have the role of increasing the contact surface with the secondary air flow and extracting the calories. However, the disadvantage of the SACOC heat exchangers is that they create additional pressure losses in the relevant secondary duct, since they disturb the air flow, which has an impact on the performance of the turbomachine as well as on the specific fuel consumption.

Their aerothermal performance (ratio between the thermal power dissipated and the pressure loss induced on the side of the secondary air flow) is low.

In addition, the cooling requirements of the lubricating fluid are increasing due to the higher rotational speeds and the power requirements to meet the specification trends on the turbomachines.

### SUMMARY OF THE INVENTION

The objective of the present invention is to provide a heat exchanger allowing to optimise its thermal performance while reducing the mechanical energy losses.

This is achieved in accordance with the invention by a heat exchanger for a turbomachine comprising a support wall and a first plurality of fins that each rise from an external surface of the support wall and intended to be swept by a first air flow, the heat exchanger comprising, downstream of the first plurality of fins a second plurality of fins that each rise from the external surface of the support wall, the first and the second plurality of fins being separated by distribution means which are configured such that the first air flow circulates outside the second plurality of fins and a second air flow circulating outside the first plurality of fins passes through the second plurality of fins.

Thus, this solution allows to achieve the above-mentioned objective. In particular, by circulating two separate air flows without crossing each other, the thermal performance is increased as the second air flow replaces the first air flow that has already passed through the first fins. This second air flow that circulates outside the heat exchanger is cooler, which increases the thermal exchange potential. In addition, the path of each air flow through the heat exchanger is reduced in length, which influences the reduction of the induced drag.

The heat exchanger also comprises one or more of the following characteristics, taken alone or in combination:
the support wall extends along a longitudinal direction L.
the distribution means are arranged at least partly between the first and second plurality of fins along the orientation of circulation of the first and second air flows in the fins.
the heat exchanger comprises a first profiled wall which is disposed upstream of the first plurality of fins and which is configured so as to guide and slow down the first air flow entering the heat exchanger through the first plurality of fins, and a second profiled wall which is disposed downstream of the second plurality of fins and which is configured so as to accelerate the second air flow exiting the heat exchanger through the second plurality of fins.
the heat exchanger comprises a first profiled panel covering the fins of the first plurality of fins and a first profiled wall which is connected upstream to the first panel, the first wall being disposed upstream of the first plurality of fins and being configured so as to guide and slow down the first air flow entering the heat exchanger through the first plurality of fins.
the distribution means comprises a first ramp arranged downstream of the first plurality of fins and rising from the external surface of the support wall, being inclined, so that the first air flow exiting the first plurality of fins is directed towards the outside of the heat exchanger.
the distribution means comprises a deflector which comprises a first profiled wall portion connected to the first panel downstream and which is defined in a plane substantially parallel to the plane of the first ramp, a plurality of stacks extending between the first profiled wall portion and the first ramp being evenly spaced apart from each other so as to form passages for the first air flow.
each stack comprises a first opening which opens onto an external surface of the first profiled wall portion and a second opening which opens onto an internal surface of the first ramp and opposite the second plurality of fins so that the second air flow circulates in the stacks through the second plurality of fins.
the heat exchanger comprises a second profiled panel covering the fins of the second plurality of fins and a second profiled wall which is connected downstream to the second profiled panel, the second wall being disposed downstream of the second plurality of fins and being configured so as to accelerate the second air flow exiting the heat exchanger through the second plurality of fins.
the deflector comprises a second profiled wall portion which is connected to the second panel, the second wall portion comprising through orifices into which the passages open.
the first wall portion comprises a first flange extending in a plane inclined to the first wall portion and at least partly covering the first opening of each stack.
the second wall portion comprises a second flange extending in a plane inclined to the second wall portion and which at least partly covers the orifices.
the distribution means comprise a second ramp arranged upstream of the second plurality of fins and extending the second opening of the stacks.
the fins are continuous and rectilinear in one longitudinal direction each, or discontinuous and disposed in staggered rows, or are corrugated.
the heat exchanger is produced by additive manufacturing.
the heat exchanger comprises a deflector which comprises external passages and internal passages formed by stacks, the internal conduits opening on the one hand outside the heat exchanger and on the other hand upstream of the second plurality of fins, the external passages arranged between two adjacent stacks opening on the one hand downstream of the first fins and on the other hand outside the heat exchanger.
the stacks are arranged between the first and second fins in the longitudinal direction.
the first profiled wall comprises a first longitudinal end forming with the support wall an air inlet having a first radial height and the second profiled wall comprises a second longitudinal end forming with the support wall an air outlet having a second radial height, the ratio between the first height and the second height being equal to or greater than 0.5.
the first profiled panel extends to a maximum radial distance from the external surface which is greater than the first and the second height of the first and second profiled walls respectively.
the first and the second panels being connected by the deflector.
the heat exchanger is produced by additive manufacturing.
the first panel, the second panel, the first wall, the second wall and the deflector are made in one-piece.
the fins of the first plurality of fins are attached to the first panel.
the fins of the second plurality of fins are attached to the second panel.
the fins of the first or second plurality of fins are made in one-piece with the first or the second panel respectively.
the heat exchanger is intended to be arranged in a secondary duct of the turbomachine.
the heat exchanger is of the air/fluid type and preferably the surface type.
the first and the second air flows are identical.
the first and the second air flows are derived from the secondary air flow circulating in the secondary duct.

The invention also relates to a turbomachine module of longitudinal axis X comprising an annular casing around the longitudinal axis in which an air flow circulates and a heat exchanger according to any of the preceding characteristics and which is arranged in the annular casing, the annular casing comprising an annular wall which guides the air flow at least partly and which has an opening or a recess in which the heat exchanger is installed with the first and second profiled panels, the first wall being connected upstream of the first panel to a segment of the annular wall and the second wall being connected downstream of the second panel to a segment of the annular wall, the first and the second panels being connected by the deflector.

The heat exchanger is buried in the wall of the annular casing.

The invention further relates to a turbomachine comprising at least one heat exchanger having any of the foregoing characteristics and/or a turbomachine module as above-mentioned.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is an axial cross-sectional view of an example of turbomachine to which the invention applies;

FIG. 2 is a perspective view of a heat exchange system intended to equip a turbomachine according to the invention;

FIG. 3 is a schematic axial sectional view of the heat exchange system according to FIG. 2;

FIG. 4 is another embodiment of a heat exchange system with discontinuous and staggered fins rising from a support wall of a heat exchanger according to the invention;

FIG. 5 illustrates schematically and in more detail an area of intersection of different heat exchange flows, without mixing them, in an example of a heat exchange system according to the invention;

FIG. 6 is a perspective and side view of an example of a heat exchange system and in particular of a deflector according to the invention;

FIG. 7 illustrates the path of a second flow through the heat exchange system according to the invention in an axial cross-section through a stack;

FIG. 8 is a perspective and rear view of a heat exchange system according to the invention;

FIG. 9 illustrates the path of a first flow through the heat exchange system according to the invention in an axial cross-section; and

FIG. 10 shows another example of a heat exchange system integrated into a turbomachine wall according to the invention in an axial cross-section.

### DETAILED DESCRIPTION OF THE INVENTION

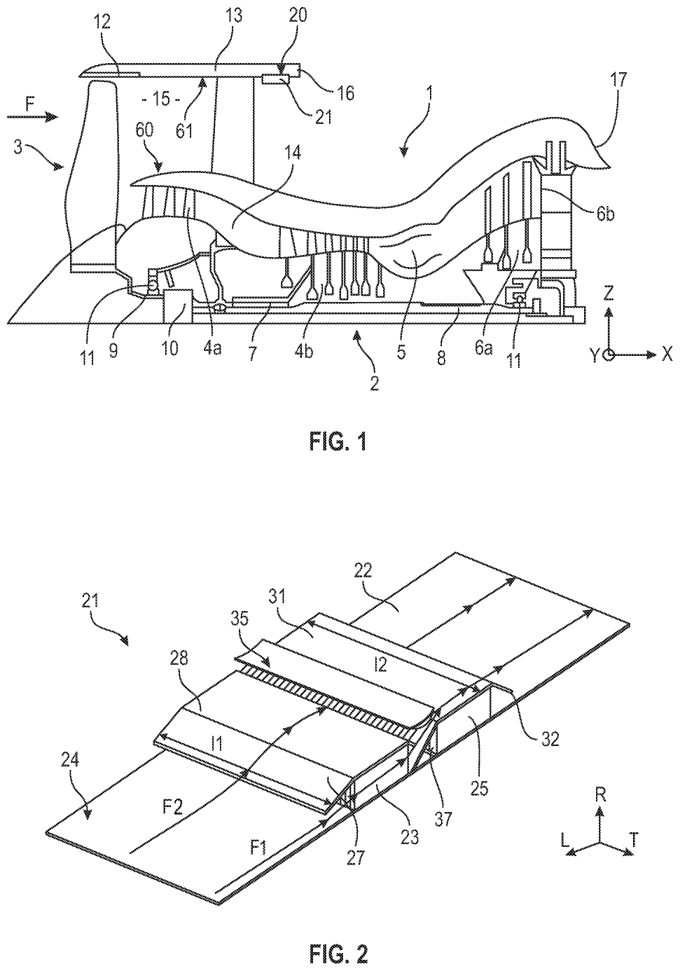

FIG. 1 shows an axial cross-sectional view of a turbomachine of longitudinal axis X to which the invention applies. The turbomachine shown is a double-flow turbomachine 1 intended to be mounted on an aircraft. Of course, the invention is not limited to this type of turbomachine.

This double-flow turbomachine 1 generally comprises a gas generator or gas turbine engine 2 with a fan 3 mounted upstream.

In the present invention, the terms “upstream” and “downstream” are defined in relation to the circulation of the gases in the turbomachine and here along the longitudinal axis X and with reference to FIG. 1 from left to right. Similarly, a turbomachine is usually made up of several modules that are manufactured independently of each other and then assembled together in a way that facilitates its assembling, dismounting and its maintenance.

The gas generator 2 comprises a gas compressor assembly (here comprising a low pressure compressor 4a and a high pressure compressor 4b), a combustion chamber 5 and a turbine assembly (here comprising a high pressure turbine 6a and a low pressure turbine 6b). Typically the turbomachine comprises a low pressure shaft 7 which connects the low pressure compressor and the low pressure turbine to form a low pressure body and a high pressure shaft 8 which connects the high pressure compressor and the high pressure turbine to form a high pressure body. The low pressure shaft 7, centred on the longitudinal axis, drives a fan shaft 9 in this example. A speed reducer 10 may be interposed, as here, between the fan shaft 9 and the low pressure shaft 7. Upstream and downstream rotation guide bearings 11 allow to guide the low-pressure shaft 7 in rotation relative to a stationary structure of the turbomachine.

The fan 3 is ducted in a fan casing 12 carried by a nacelle 13 and generates a primary air flow which circulates through the gas generator 2 in a primary duct 14 and a secondary air flow which circulates in a secondary duct 15 around the gas generator 2. The secondary air flow is ejected through a secondary nozzle 16 terminating the nacelle 13 while the primary air flow is ejected outside the turbomachine via an ejection nozzle 17 located downstream of the gas generator 2. In the following, the fan casing 12 and the nacelle 13 are considered as one single piece.

The guide bearings 11 and the speed reducer 10 in this example of configuration of the turbomachine must be lubricated and/or cooled to ensure the performance of the turbomachine. The power generated by these is dissipated in a fluid from a fluid supply source installed in the turbomachine, which allows to lubricate and/or cool various members and/or equipment of the turbomachine. Of course, other items of equipment of the turbomachine generates a lot of heat that must be extracted from its environment.

To this end, the turbomachine comprises a heat exchange system 20 which allows to cool the fluid intended to lubricate and/or cool these members and/or items of equipment. In the present example, the fluid is an oil and the cold source intended to cool the oil is the air flow circulating in the turbomachine, in particular the secondary air flow. The heat exchange system comprises a heat exchanger 21 which is carried by the fan casing of the turbomachine as shown schematically in FIG. 1. In particular, the heat exchanger 21 is arranged in the secondary duct 15 so that the secondary air flow passes through it. The heat exchanger is of the air/oil surface type.

With reference to FIG. 2, the heat exchanger 21 comprises a support wall 22 which extends along a longitudinal direction L. The support wall 22 is here substantially flat. This wall may not be completely flat but curved to follow the profile of the wall of the fan casing 12 which is intended to carry the heat exchanger 21 and which is substantially cylindrical (and centred on the longitudinal axis X). The heat exchanger 21 may be annular and occupy the entire wall of the fan casing 12. Alternatively, the heat exchanger 21 is arranged on a segment of the fan casing 12.

The heat exchanger 21 also comprises a first plurality of fins 23 which each rise here from an external surface 24 of the support wall 22. The fins 23 extend in a radial direction R which is perpendicular to the longitudinal direction. We use the term “direction” to describe the heat exchanger 21 in particular. The radial direction is parallel to a radial axis that extends from the longitudinal axis of the turbomachine. The longitudinal direction is parallel to the longitudinal axis of the turbomachine in the installation situation.

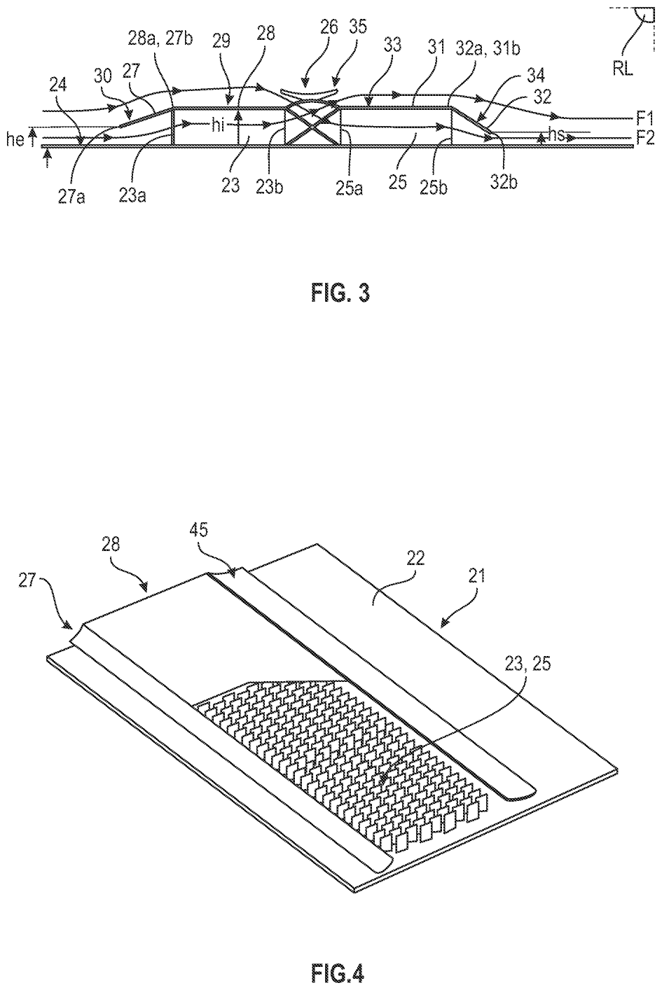

As can be seen in FIGS. 2 and 3, the fins 23 are continuous and rectilinear. Advantageously, the fins 23 are rectangular in shape. These each extend along the longitudinal direction L (substantially parallel to the circulation or flow of the air flow in the turbomachine and in particular in the heat exchanger). More specifically, each fin 23 is flat. The fins 23 are arranged successively and regularly on the radially external surface 24 along a transverse direction T which is perpendicular to the longitudinal direction L and the radial direction R. They are still substantially parallel to each other. In FIG. 3, each fin 23 of the first plurality of fins has a leading edge 23a and a trailing edge 23b opposite each other in the circulation direction of the air flow.

As can also be seen in FIGS. 2 and 3, the heat exchanger 21 comprises a second plurality of fins 25 which each rise here from the external surface 24 of the support wall 22 in the radial direction. The fins 25 are arranged downstream of the first plurality of fins 23 (in the circulation direction of the air flow). As shown in Figures and 3, the fins 25 of the first plurality of fins 23 are arranged downstream of the first plurality of fins along the longitudinal direction L. In the present example, the fins 25 of the second plurality of fins are similar to the fins 23 of the first plurality of fins. In other words, these fins 25 are continuous, rectilinear and flat. They are also rectangular in shape in an axial cross-section. The fins 25 each have a leading edge 25a and a trailing edge 25b.

In the partially cutaway view of FIG. 4, the fins of the first and/or second plurality of fins 23, 25 may also be discontinuous and arranged in staggered rows (offset pitch) in the radial or longitudinal direction. The fins 23, 25 extend from the external surface 24 of the support wall 23 and in the flow direction of the air flow F1, F2. There are rows of fins in the longitudinal direction and in the transverse direction T. The fins disposed in this way allow to intensify the thermal boundary layers by interruption and redevelopment, which allows to significantly reduce the exchange surface for a given dissipated power or to increase the power that can be dissipated in a given overall dimension. Alternatively, the fins 23, 25 can also be corrugated in the radial or longitudinal direction. Alternatively, the fins 23, 25 can be trapezoidal in shape.

Two air flows, designated first air flow F1 and second air flow F2 (see FIGS. 2, 3) are intended to sweep the fins 23 and 25 without crossing each other. These first and second air flows F1, F2 are derived from the secondary air flow that enters the fan casing 12 (in the secondary duct 15) and is divided into two. The first and the second air flows are identical. The first air flow F1 and the second air flow F2 circulate outside the heat exchanger 21 and through the fins 23 or 25.

To this end, the first and the second plurality of fins 23, 25 are separated by distribution means 26 for the first and second air flows F1, F2 which are configured so that the first air flow F1 circulates outside the second plurality of fins 25 and the second air flow F2 circulating outside the first plurality of fins 23 passes through the second plurality of fins 25. It is understood that the distribution means are arranged at least partly between the first and second plurality of fins along the circulation direction of the first and second air flows in the fins (or along the longitudinal direction L). The first air flow F1 is intended to circulate only through the fins 23. Conversely, the second air flow F2 is intended to circulate only through (between) the fins 25. Such a configuration is compact and allows for axial as well as radial gain.

In particular, in FIGS. 2 and 3, the heat exchanger 21 comprises a first profiled wall 27 disposed upstream of the fins 23 (along the circulation direction of the air flow along the external surface 24) and which is configured to direct and guide the first air flow F1 entering the heat exchanger 21, and in particular the fins 23. This first wall 27 is also configured to slow the air flow entering the heat exchanger. It has a divergent profile. The first wall 27 extends over a width I1 at least equal to the distance over which the fins are disposed. In particular, the I1 of the first profiled wall 27 is greater than the width over which the fins are disposed (along the transverse direction T).

The first wall 27 is flat and is defined in a plane which is inclined with respect to the longitudinal direction L. More precisely, the first wall 27 comprises a first longitudinal end 27a, upstream, forming with the support wall 22 an air inlet which has a first predetermined height he along the radial direction. The first height he is less than the radial height hi of the fins. The height hi of the fins is between 5 mm and 30 mm. The first wall 27 comprises a second, downstream, longitudinal end 27b which is connected to the summit of the leading edge 23a of each fin 23. In other words, the first wall 27 is inclined by flaring downstream. In particular, the distribution means comprise an air inlet for the second air flow and an air outlet for the first air flow. The air inlet of the distribution means is different from the air inlet at the level of the first fins.

The heat exchanger 21 comprises a first profiled panel 28 covering the fins 23. In this way, the first panel allows the flow of the air flow inside the heat exchanger 21 to be controlled without the risk of bypassing the air flow through the heat exchanger. The fins 23 are thus arranged radially between the support wall 22 and the first profiled panel 28. In this example of embodiment, the first panel 28 is connected to the first wall 27 and extends (downstream) along the longitudinal direction L. The first panel 28 also has the same width (along the transverse direction) as that of the first wall 27. As shown in FIG. 3, the first panel 28 is flat. However, the panel 28 is substantially circular or curved (around the longitudinal axis X when installed in the turbomachine). In particular, the panel 28 comprises a first longitudinal edge 28a which joins the first longitudinal end 27b of the first wall 27. As illustrated, the external peripheral surface 29 of the panel 28 has a surface continuity with the external surface 30 of the first wall 27. The panel 28 extends at a radial distance equal to or greater than that of the fins 23. In other words, this radial distance is greater than the first height he of the air inlet of the first wall 27.

The first wall 27 and the panel 28 are advantageously made in one-piece and for example by an additive manufacturing method (or 3D printing) such as a laser fusion method on powder bed.

Advantageously, but not restrictively, the fins 23 are attached, for example by brazing, to the panel 28 and/or to the support wall 22. They are therefore fitted. Alternatively, the fins 23 and the support wall 22 are formed in one-piece (i.e. from one material and monobloc) and advantageously by additive manufacturing. Similarly, the fins 23 and the panel 28 can be made in one single piece. The additive manufacturing is carried out, for example, in a direction from upstream to downstream of the heat exchanger. In this case, in order to facilitate the additive manufacturing and in particular without support, the leading edge 23a of the fins 23 has an angle of inclination with the radial direction.

Of course, the heat exchanger 21 as a whole can be manufactured by another manufacturing method such as forging.

In addition, disposing the panel 28 on the fins 23 allows to improve the mechanical strength of the heat exchanger 21 and thereby reduces the thicknesses of the fins 23. However, a thickness reduction of the fins 23 also allows to reduce the mass of the heat exchanger 21.

As can be seen in FIGS. 2 to 4, the second plurality of fins 25 is also covered by a second panel 31 so as to also control the flow of the air flow inside the heat exchanger 21 and without the risk of bypass. The fins 25 are arranged radially between the support wall 22 and the second profiled panel 31. As with the first panel 28, the second panel 31 extends over a width I2 at least equal to the distance over which the fins 25 are disposed. The panel 31 is also flat but may be circular in radial cross-section or curved in the installation situation about the longitudinal axis X. The second panel 31 is connected downstream to a second profiled wall 32. The latter is disposed downstream of the fins 25 so as to reduce the recirculation phenomena that occur downstream of the fins. The second profiled wall 32 is also configured to accelerate the flow at the outlet of the heat exchanger 21. The distribution means connect the first and second panels 28, 31 as explained below.

The second wall 32 has substantially the same configuration as that of the first wall 27. However, it has a convergent profile. The width of the second wall 32 is the same as the width (I1) of the first wall 27 and also the width (I2) of the second panel 32 (and wider than the width over which the fins are disposed in the transverse direction T). The second wall 32 also comprises a first end 32a connected to the second longitudinal edge 31b of the second panel 31. The second panel 31 has an external peripheral surface 33 having a surface continuity with the external surface 34 of the second wall 32. The latter comprises a second, downstream end 32b, forming with the support wall 22 an air outlet which has a second predetermined height hs in the radial direction. The second height hs is less than the height hi of the fins. The first end 32a of the second wall 32 is connected to the summits of the trailing edges 25b of the fins 25. In other words, the second wall 32 is inclined by flaring upwards. The radial distance of the panels is equal to or greater than the first and second heights he, hs of the walls 27, 32. The air outlet downstream of the second plurality of fins for the second air flow is different from the air outlet of the distribution means.

In the present example of embodiment, the ratio between the first height he and the second height hs is between 0.5 and 1.

Alternatively, not shown, the first and the second walls 27, 32 each have a substantially corrugated or curved shape in a plane RL (formed by the perpendicular longitudinal L and radial R directions) perpendicular to the plane LT of the support wall 22.

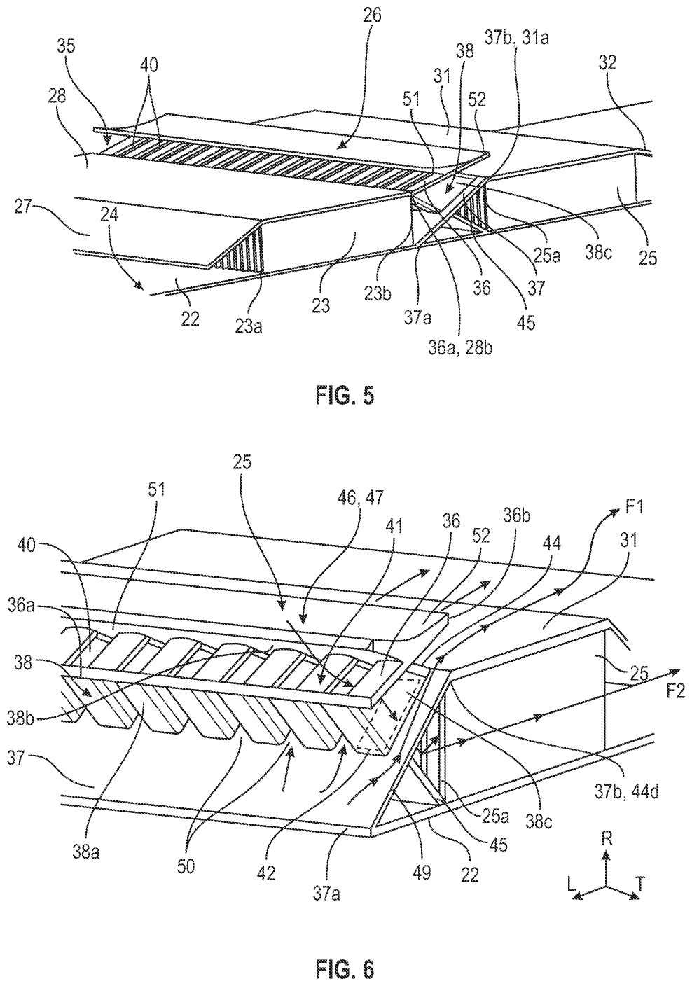

In FIGS. 5 to 9, the distribution means 26, between the two pluralities of fins 23, 25, comprise a deflector 35 carried at least by the first panel 28. This deflector 35 has an X-shaped axial cross-section. In particular, the deflector 35 comprises a first profiled wall portion 36 with an upstream end 36a which is connected to the second longitudinal edge 28b of the first panel 28. The first wall portion 36 is inclined downstream. In the present example, the first wall portion 36 is defined in a plane that is substantially parallel to the plane of a first ramp 37. The plane of the ramp 37 is inclined at an angle of between 20 and 70°. The first ramp 37 comprises a first longitudinal end 37a which is connected to the support wall 22 and a second longitudinal end 37b to a first longitudinal edge 31a of the second panel 31. The first longitudinal end 37a rises axially (along the longitudinal direction L) downstream of the roots of the trailing edges 23b of the fins 23, and from the external surface 24 of the support wall 22. The second longitudinal end 37b is also connected to the summits of the leading edges 25a of the fins 25. In other words, the first ramp 37 is inclined downstream. In this way, the air flow exiting the first plurality of fins 23 is directed outside of the heat exchanger 21 via the first ramp 37.

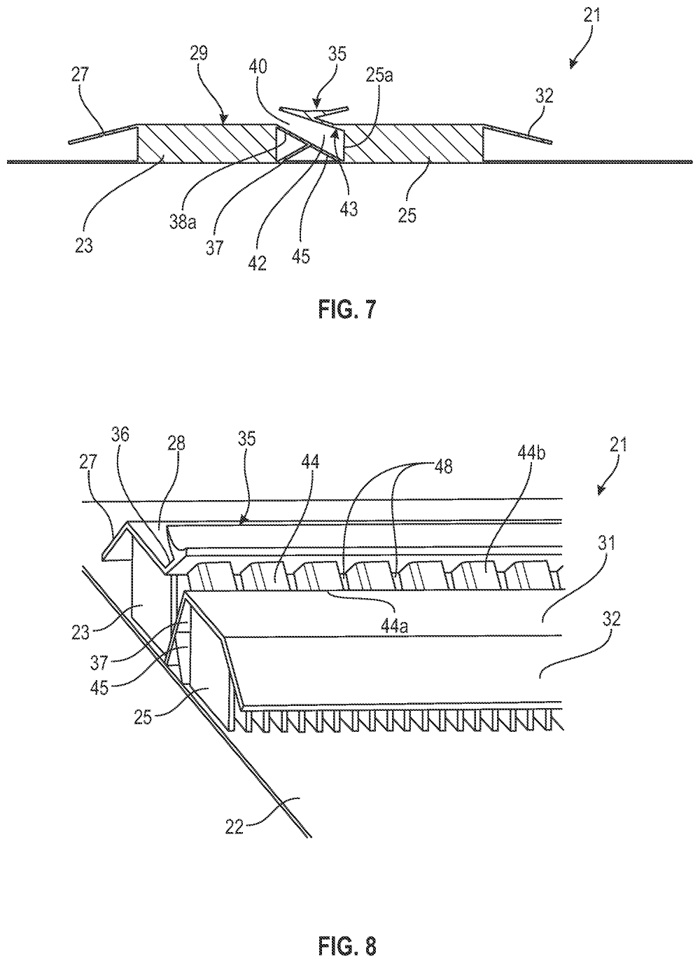

Between the first wall portion 36 and the first ramp 37 a plurality of stacks 38 extend substantially radially. The stacks 38 are evenly spaced from each other so as to form passages 50 for the first air flow F1. In this way, the air flows circulate and are distributed separately in the distribution means. The first air flow circulates on the one hand between the first ramp 37 and the first wall portion 36 and on the other hand through the passages 50 (between each adjacent stack 38 along the transverse direction T). The arrangement of the stacks in the distribution means between the walls of them and the first and second plurality of fins form a compact means. Each stack 38 comprises an upstream side 38a and a downstream side 38b which are connected by two lateral sides 38c. The stacks 38 are each hollow. Each stack 38 comprises a first opening 40 which is defined in the first wall portion 36 of the deflector 35. The first opening 40 opens onto an external surface 41 of the first wall portion 36. The first opening 40 passes through the wall of the first wall portion on both sides. Each stack 38 also comprises a second opening 42 (shown dotted in FIG. 6) which is defined in the first ramp 37. More specifically, the second opening 42 opens onto an internal surface 43 of the first ramp 37 as shown in FIG. 7. This internal surface 43 is oriented facing the leading edges 25a of the fins 25. The second opening 42 passes through the ramp 37 on both sides. The sides 38a, 38b, 38c delimit the first opening 40 and the second opening 42. In other words, each stack 38 (forming an internal conduit) is in fluid communication with the outside of the heat exchanger 21 and the interior of the fins 25. More specifically, each opening 40, 42 opens into the internal conduit of a stack 38. In this way, as shown in FIG. 7, the second air flow F2 which circulates outside the heat exchanger, sweeping the external surface 29 of the panel 28, passes through the stacks 38 via the first opening 40, and opens, via the second opening 42, through the second plurality of fins 25.

With reference to FIGS. 6 and 8, the deflector 35 comprises a second wall portion 44 which is defined in a plane which is transverse to the plane of the first wall portion 36. The second wall portion 44 is connected to the first portion 36 at the level of a central junction (in the centre of the upper X). The second wall portion 44 comprises a second end 44a which is connected to the first longitudinal edge of the second panel 31 (or close to the longitudinal edge). In this way, the deflector 35 is also carried by the second panel 31.

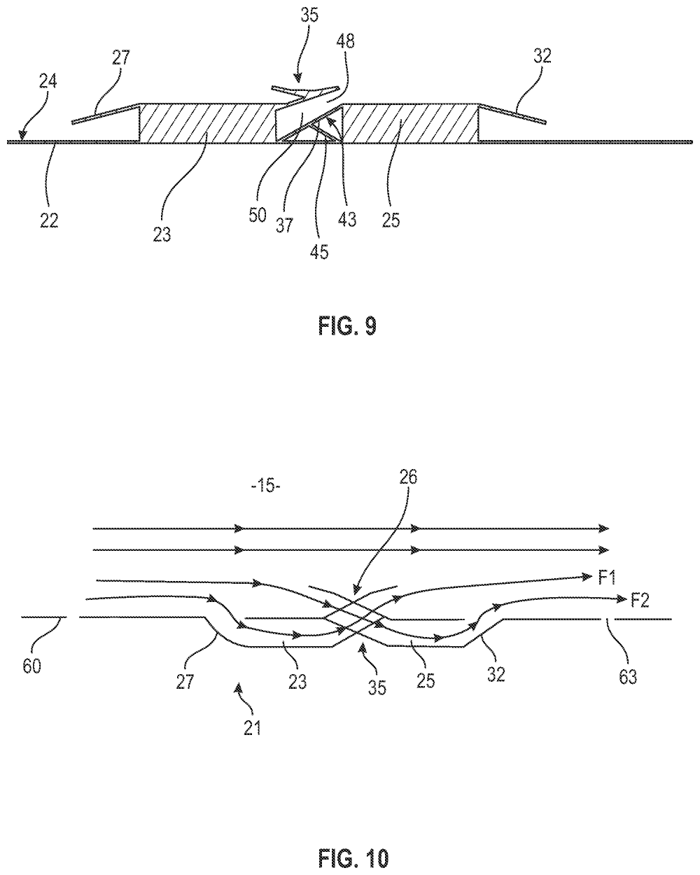

As can be seen in FIG. 8, the first wall portion 44 comprises a plurality of segments 44b which are evenly distributed along the transverse direction T. The upstream side 38a is defined in (or by) each segment 44b of the second wall portion 44. The second wall portion 44 also comprises orifices 48 which pass through its wall on either side in the direction transverse to the plane in which the second wall portion 44 is defined. Each orifice 48 is arranged transversely between two stacks 38. More specifically, each orifice 48 is disposed opposite and in line with a passage 50 which is formed between two adjacent stacks 38. However, the first or the last stack in the transverse direction is at a distance from a lateral rim 49 of the first ramp 37. Similarly, as can be seen in FIG. 6, the second wall portion 44 does not extend to the lateral rim 49. In other words, the second wall portion 44 extends in line with the lateral side 38c of the first or of the second stack 38 in the transverse direction. In this way, as shown in FIG. 9, the first air flow F1 that circulates through the fins 23 opens onto the ramp 37, passes through the passage or the passages 50, and opens, via the orifices 48, to the outside of the heat exchanger. The first air flow may pass through the passage 50 closest to the lateral rim 49 and circulate towards the outside of the heat exchanger.

The first wall portion 36 of the deflector 35 comprises a first flange 51 which at least partially overlaps the first wall portion 36 with the first openings 40. The free end of the first flange 51 is radially spaced from the first wall portion 36. Similarly, the second wall portion 44 comprises a second flange 52 which partly overlaps the second wall portion 44 with the orifices 48. The first and second flanges extend in opposite directions. The first flange 51 allows the second air flow to be directed towards the stacks 38. The second flange 52 allows the first air flow to be directed at the outlet of the orifices 48. The free end 36b of the second flange is radially spaced from the second panel 31. As shown in FIG. 6, the external surface 46, 47 of the first flange and the second flange have a surface continuity.

The distribution means 26 also comprise a second ramp 45 which extends from the internal surface 43 of the first ramp 37 to the roots of the fins 25. Advantageously, but not restrictively, the second ramp 45 extends downstream of the second openings 42 so as to guide the air flow towards the interior of the fins 25.

The panels 28, 31 and the deflector 35 can be made in one-piece (integral) so as to simplify the manufacture and the mounting of the heat exchanger. The additive manufacturing is a manufacturing method that allow to achieve this goal. It can be foreseen that the fins 23, 25 are also manufactured in one-piece with the panels and the deflector 35 and following the same manufacturing method.

Thus, the first air flow F1 entering the heat exchanger 21, sweeps across the external surface 24 of the support 22, passes through the first fins 23, passes through the passage or the passages 50 arranged between the stacks 38 (or between two sides) and discharges towards the outside of the heat exchanger through the orifice or the orifices 48. The first air flow, at the outlet of the orifice 48, sweeps across the external surface of the second panel. As for the second air flow F2 which circulates outside the heat exchanger 21, it enters the heat exchanger at the level of the first openings 40, penetrates inside the stacks 38 and then discharges into the second fins 25 through the second openings 42. The second air flow then leaves the heat exchanger through the outlet and sweeps across the external surface 24 of the support wall 22. Each of the first and second flows travels a short path through the heat exchanger, which reduces the drag. Indeed, their respective paths are substantially identical to those of a conventional exchanger with only one plurality of fins 23 or 25.

FIG. 10 shows an embodiment of a heat exchanger buried in an annular wall 60, 61 of the turbomachine. Here the annular wall is that of a secondary duct and guides at least partly the secondary air flow. The heat exchanger 21 in its arrangement is swept and/or passed through by the secondary air flow of the turbomachine. The secondary duct 15 is delimited by a radially internal annular wall 60 and a radially external annular wall 61. The latter is carried at least partly by the fan casing 12. According to the example of embodiment, the annular wall 60 comprises an opening or a recess 63 in which the heat exchanger 21 is installed. In particular, the first wall 27 upstream of the first panel 28 to a segment of the annular wall 60 and the second wall 32 is connected downstream of the second panel 31 to a segment of the annular wall. The first panel and the second panel are connected by the deflector 35. The panels 28, 31 are offset radially inwards from the wall 60. In this way, the fins 23, 25 are at least partly buried in the wall 60 of the secondary duct 15, which allows to minimise the disturbance of the flow of the air flow in the secondary duct. Furthermore, as in the previous embodiments, the first and second flows pass through the heat exchanger 21 via internal passages and conduits of the deflector 35. The deflector 35 comprises for this purpose stacks extending axially (or longitudinally) between the first and second fins 23, 25. The adjacent stacks form the passages 50 placing the first plurality of fins 23 in fluid communication with the outside of the heat exchanger 21 via orifices 48. The stacks also form the internal conduits in fluid communication with the second plurality of fins 25. Each stack extends between a wall portion of the exchanger and a ramp being evenly spaced from each other so as to form the external passages for the first air flow. The wall portion comprises first openings 40 in communication with the outside of the exchanger and in this case the duct 15 and second openings 42 opening upstream of the second fins 25. In this way, the first air flow F1 which circulates through the fins 23 opens onto the ramp 37, passes through the passage or the passages 50, and opens, via the orifices 48, outside the heat exchanger (in the secondary duct) and the second air flow F2 which circulates outside the heat exchanger (in the secondary duct), passes through the stacks 38 via the first opening 40, and opens, via the second opening 42, through the second plurality of fins 25.

1. A heat exchanger for a turbomachine comprising a support wall extending in a longitudinal direction and a first plurality of fins that each rise from an external surface of the support wall and intended to be swept by a first air flow, characterised in that the heat exchanger comprises, downstream of the first plurality of fins in the longitudinal direction a second plurality of fins that each rise from the external surface of the support wall, the first and the second plurality of fins being separated at least partly by distribution means, in the longitudinal direction, which are configured such that the first air flow circulates outside the second plurality of fins and a second air flow circulating outside the first plurality of fins passes through the second plurality of fins.

2. The heat exchanger according to claim 1, characterised in that it comprises a first profiled wall which is disposed upstream of the first plurality of fins and which is configured so as to guide and slow down the first air flow entering the heat exchanger through the first plurality of fins, and a second profiled wall which is disposed downstream of the second plurality of fins and which is configured so as to accelerate the second air flow exiting the heat exchanger through the second plurality of fins.

3. The heat exchanger according to claim 2, characterised in that it comprises a first profiled panel covering the fins of the first plurality of fins, the first profiled wall being connected, upstream, to the first profiled panel.

4. The heat exchanger according to claims 1, characterised in that the distribution means comprise a first ramp arranged downstream of the first plurality of fins and which rises from the external surface of the support wall, being inclined, so that the first air flow exiting from the first plurality of fins is directed towards an outside of the heat exchanger.

5. The heat exchanger according to claim 1, characterised in that the distribution means comprise a deflector which comprises a first profiled wall portion connected to a first panel, downstream and which is defined in a plane substantially parallel to a plane of a first ramp, a plurality of stacks extending between the first profiled wall portion and the first ramp being evenly spaced apart from each other so as to form passages for the first air flow.

6. The heat exchanger according to claim 5, characterised in that each stack comprises a first opening which opens onto an external surface of the first profiled wall portion and a second opening which opens onto an internal surface of the first ramp and opposite the second plurality of fins so that the second air flow circulates in the stacks through the second plurality of fins.

7. The heat exchanger according to claim 2, characterised in that it comprises a second profiled panel covering the fins of the second plurality of fins, the second profiled wall being connected, downstream, to the second profiled panel.

8. The heat exchanger according to claim 7, further comprising a deflector, characterised in that the deflector comprises a second profiled wall portion which is connected to the second profiled panel, the second profiled wall portion comprising through orifices into which passages open.

9. The heat exchanger as claimed in claim 6, characterised in that the first profiled wall portion comprises a first flange extending in a plane inclined to the first profiled wall portion and at least partly covering the first opening of each stack.

10. The heat exchanger according to claim 8, characterised in that the second wall portion comprises a second flange extending in a plane inclined to the second wall portion and which at least partly covers the orifices.

11. The heat exchanger according to claim 6, characterised in that the distribution means comprise a second ramp arranged upstream of the second plurality of fins and extending the second opening of the stacks.

12. The heat exchanger according to claim 1, characterised in that the fins are continuous and rectilinear each along a longitudinal direction, or discontinuous and disposed in staggered rows, or are corrugated.

13. The heat exchanger according to claim 1, characterised in that it is produced by additive manufacturing.

14. A turbomachine module with a longitudinal axis, comprising a casing which is annular about the longitudinal axis and through which an air flow circulates, and a heat exchanger according to claim 1, which is arranged in the annular casing, the annular casing comprising an annular wall which guides the air flow at least partly and which has an opening or a recess in which the heat exchanger with the first profiled and second panels is installed, the first wall being connected upstream of a first panel to a segment of the annular wall and a second wall being connected downstream of the second panel to a segment of the annular wall, the first panel and the second panel being connected by a deflector.

15. The turbomachine comprising at least one heat exchanger according to claim 1 and/or a turbomachine module according to claim 1.
